(19) United States
(12) Patent Application Publication
(10) Pub. No.: US 2018/0131792 A1
(43) Pub. Date: May 10, 2018

(54) ELECTRONIC DEVICE

(71) Applicant: SHARP KABUSHIKI KAISHA, Sakai City, Osaka (JP)

(72) Inventor: KOSUKE TAKEDA, Sakai City (JP)

(21) Appl. No.: 15/570,177

(22) PCT Filed: Apr. 13, 2016
(86) PCT No.: PCT/JP2016/002008

§ 371 Date: Oct. 27, 2017

(30) Foreign Application Priority Data
Apr. 28, 2015 (JP) 2015-092067

(51) Int. Cl. H04M 1/02; G09F 3/00; H04B 1/3816; G06K 13/08; H04M 1/21

(52) U.S. Cl. CPC H04M 1/0274; G09F 3/0289; H04B 1/3816; H04M 1/0237; H04M 1/21; H04M 2250/14; G06K 13/0831

(57) ABSTRACT

An indication sheet 20 of an electronic device includes: a base sheet 21 which has one end portion 21a coupled to a portion located inward from an indication sheet opening 3a and configured to be housed through the indication sheet opening 3a while being at a folded position; and a drawable part 22 which has a higher stiffness than the base sheet 21, to which the other end portion 21b of the base sheet 21 continues, and which can be pulled out through the indication sheet opening 3a. When the drawable part 22 has been pulled out and the base sheet 21 has been unfolded, information described on the base sheet 21 is exposed outside the indication sheet opening 3a. In this manner, as large an amount of information as possible may be described on the indication sheet even if a limited space is available.

### TECHNICAL FIELD

The present invention relates to an electronic device including an indication member which can be slid in and out of a casing.

### BACKGROUND ART

As disclosed in Patent Document 1, it has been known to indicate important information such as an international mobile equipment identifier (IMEI) and a serial number on a portion concealed with a battery inside a device. However, in recent years, more and more electronic devices such as smartphones are designed to have no battery cover because they include a rechargeable battery which is unloadable from them.

In view of this, it has been known to indicate the important information on a plate which is provided in a space inside a casing and can be pulled out from the casing. For example, Patent Document 2 discloses a device including a card on which phone numbers and the like are described and which has engagement projections on its left and right ends. This card can be slid in and out of the device, in correspondence to a range in which the projections can move in slots of a card holder.

### CITATION LIST

### Patent Documents

Patent Document 1: Japanese Unexamined Patent Publication No. 2007-306453

Patent Document 2: Japanese Utility Model Publication No. S62-100739

### SUMMARY OF THE INVENTION

### Technical Problem

An electronic device which is large to some extent, such as a telephone set disclosed in Patent Document 2, may include one card on which a certain amount of information is described. However, it is difficult, in a small electronic device such as a smartphone, to provide a space where an indication member such as a card is arranged. Thus, a necessary amount of information cannot be described inside such a small electronic device.

In view of the foregoing, it is therefore an object of the present invention to enable as large an amount of information as possible to be described even if a limited space is available in an electronic device.

### Solution to the Problem

In order to achieve the object, according to the present invention, an indication member includes a foldable base sheet.

Specifically, the present invention is directed to an electronic device including: an indication member which can be slid in and out; and a casing having an indication member opening through which the indication member is slid in and out of the casing.

The indication member includes
a base sheet which has one end portion coupled to a portion located inward from the indication member opening, and which is configured to be folded to be housed in the casing, and
a drawable part which continues to the other end portion of the base sheet and which is able to be pulled out through the indication member opening.

The electronic device is configured such that when the base sheet is at a pulled-out position, information described on the indication member is exposed outside the indication member opening.

In this configuration, since the base sheet is folded to be housed, the casing needs a small space for housing the indication member. Further, the necessary information may be described on a portion which is exposed outside the indication member opening when the base sheet is at a pulled-out position. This may lead to an increase in the describable information.

### Advantages of the Invention

As can be seen, the present invention includes the base sheet on which information may be described and of which one end portion is coupled to an inner portion of the casing and the other end portion continues to the drawable part. The base sheet is configured to be folded to be housed through the indication member opening. Thus, in the electronic device of the present invention, as large an amount of information as possible may be described even if a limited space is available.

### BRIEF DESCRIPTION OF THE DRAWINGS

FIG. 1 is an enlarged cross-sectional view taken along the line I-I in FIG. 2.

FIG. 2 is a perspective view of a smartphone according to a first embodiment of the present invention, and also shows a portion of an upper end of the smartphone with a connector cover detached, on an enlarged scale.

FIG. 3 is an exploded perspective view of the smartphone according to the first embodiment of the present invention.

FIG. 4 is a perspective view showing, on an enlarged scale, a sub-substrate and a surrounding area thereof.

Portion (A) of FIG. 5 is an enlarged perspective view of an indication sheet as viewed from the backside, and Portion (B) of FIG. 5 is an enlarged perspective view of the indication sheet as viewed from the front.

Portions (A), (B), and (C) of FIG. 6 are enlarged cross-sectional views of a smartphone, respectively showing a state where an indication sheet is at fully pulled-out position, a state where the indication sheet has just started to be inserted, and a state where the indication sheet has been inserted further.

FIG. 7 is a front view showing, on an enlarged scale, a portion of a drawable part according to a variation of the first embodiment.

FIG. 8 corresponds to FIG. 1 and shows a second embodiment of the present invention.

FIG. 9 is an enlarged cross-sectional view showing an indication sheet according to the second embodiment and a surrounding area thereof.

Portion (A) of FIG. 10 is a front view of unfoldable portions of an indication sheet in an open state, according to a third embodiment of the present invention, and Portion (B) of FIG. 10 is an enlarged cross-sectional view taken along the line XB-XB in Portion (A) of FIG. 10.

Portion (A) of FIG. 11 is a front view of the unfoldable portions of the indication sheet in a closed state, according to the third embodiment of the present invention, and Portion (B) of FIG. 11 is an enlarged cross-sectional view taken along the line XIB-XIB in Portion (A) of FIG. 11.

FIG. 12 corresponds to Portion (A) of FIG. 10, and shows a variation of the third embodiment.

### DESCRIPTION OF EMBODIMENTS

A first embodiment of the present invention will now be described with reference to the drawings.

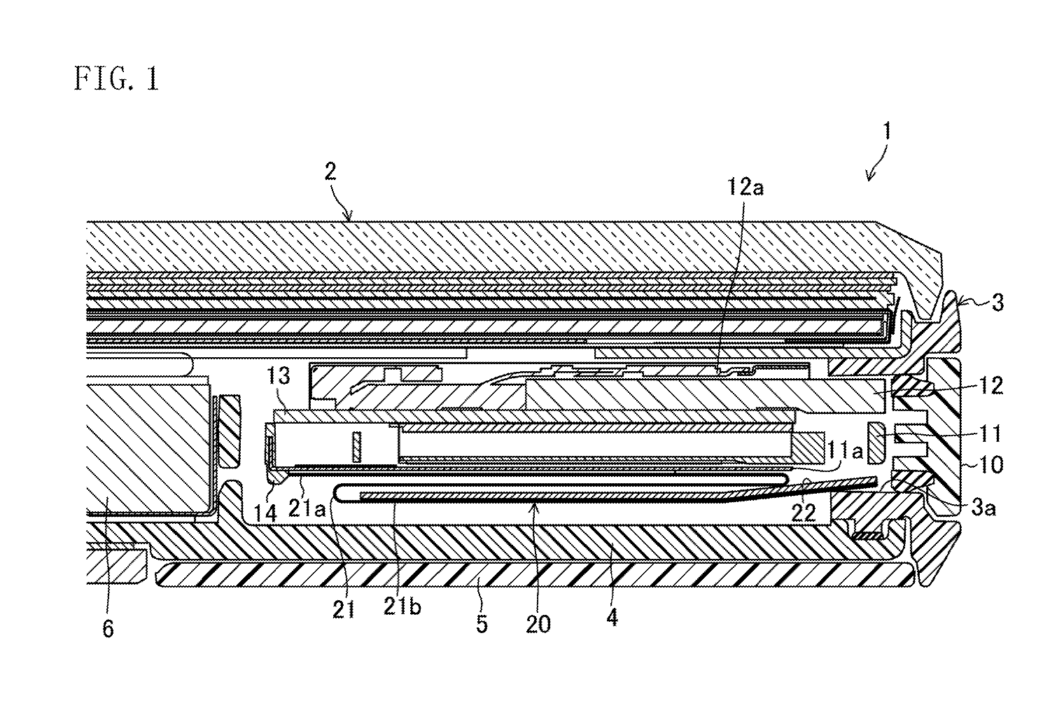

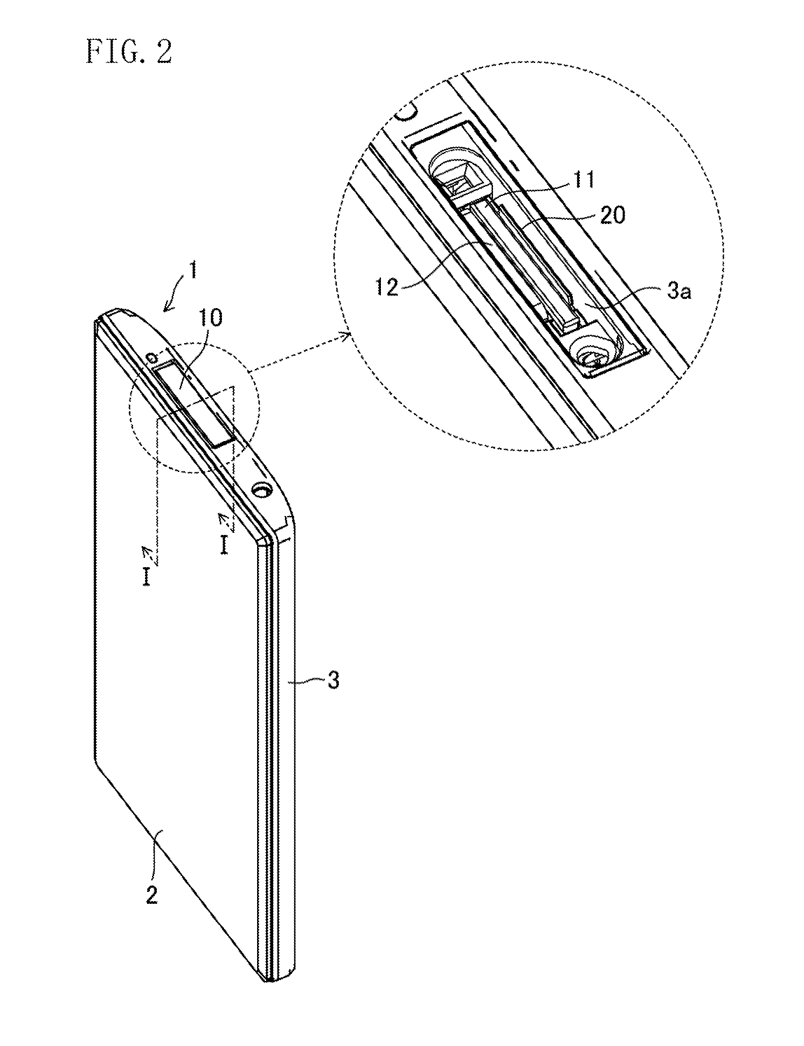

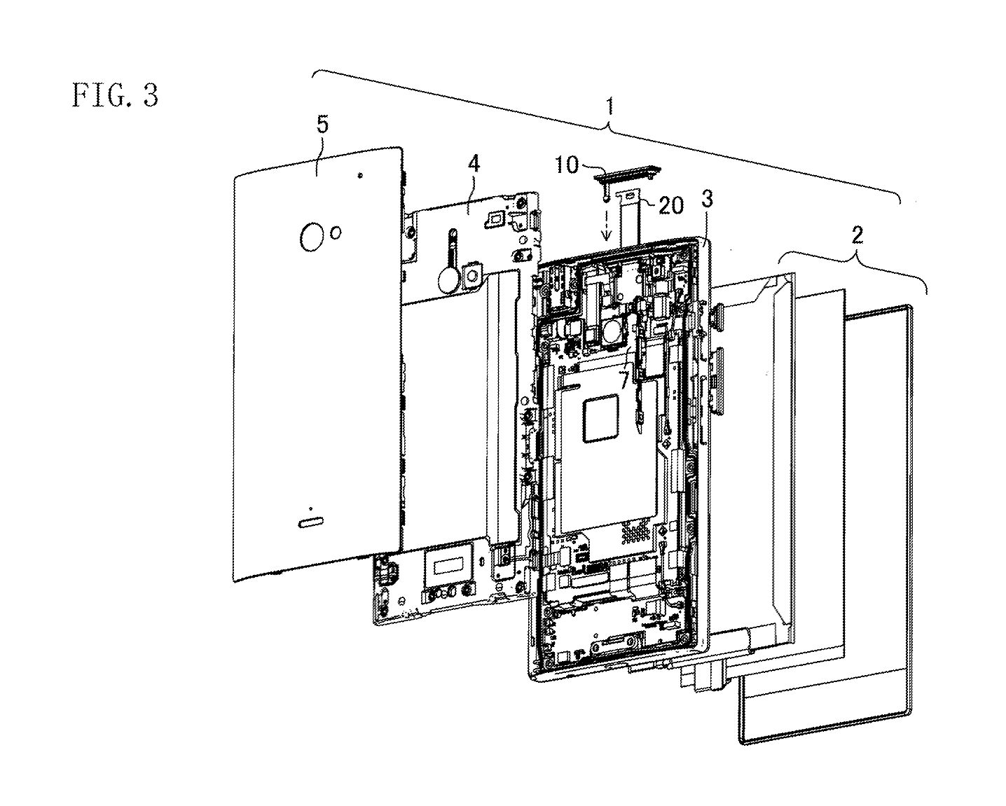

FIGS. 2 and 3 show an electronic device according to the first embodiment of the present invention and configured as a smartphone 1. The smartphone 1 includes, near its front surface which is located front as viewed by a user, a front side cabinet 3 which functions as a casing and houses a liquid crystal display unit 2 including, for example, a touch panel. The smartphone 1 further includes a backside cabinet 4 covering a backside of the front side cabinet 3, and a rear cover 5 covering a backside of the backside cabinet 4. A rechargeable battery 6 (shown in FIG. 1) and a main substrate 7 which controls the entire smartphone 1 are housed in a housing space between the front side cabinet 3 and the backside cabinet 4. The rear cover 5 does not have to be provided as a separate component in a case where a cabinet into which the backside cabinet 4 and the rear cover 5 are integrated is provided, for example.

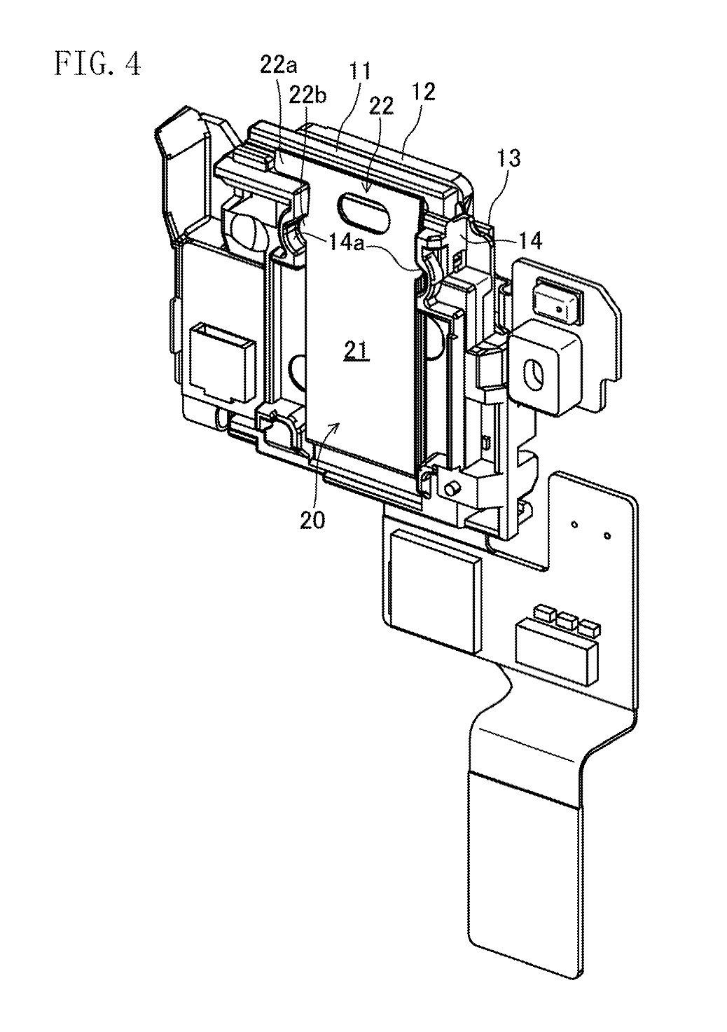

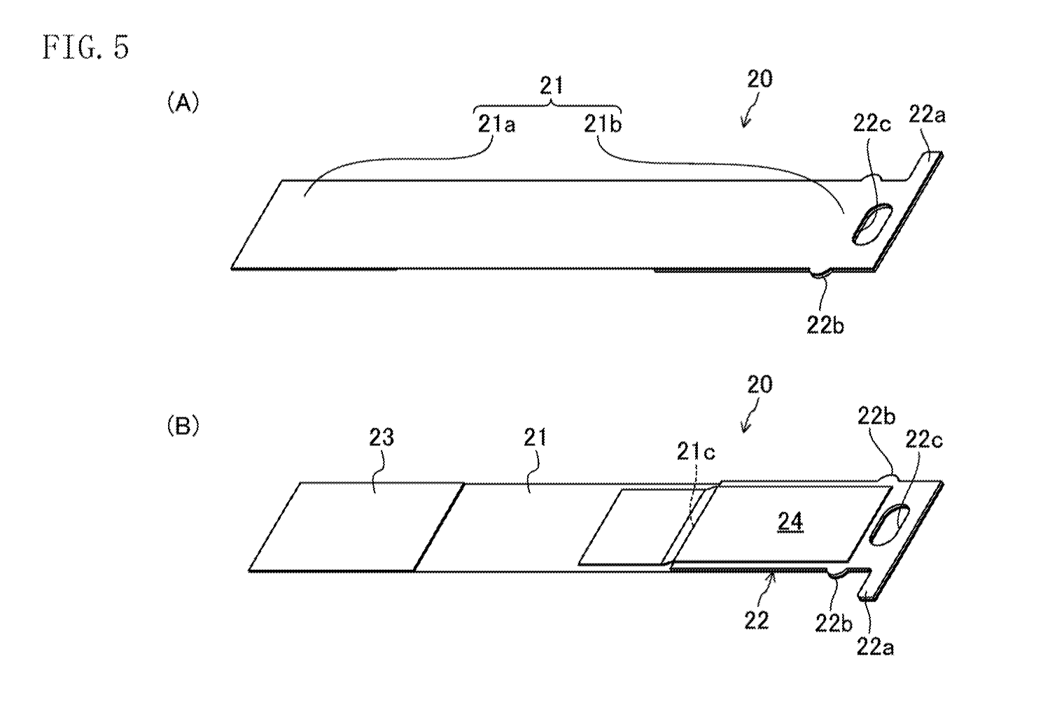

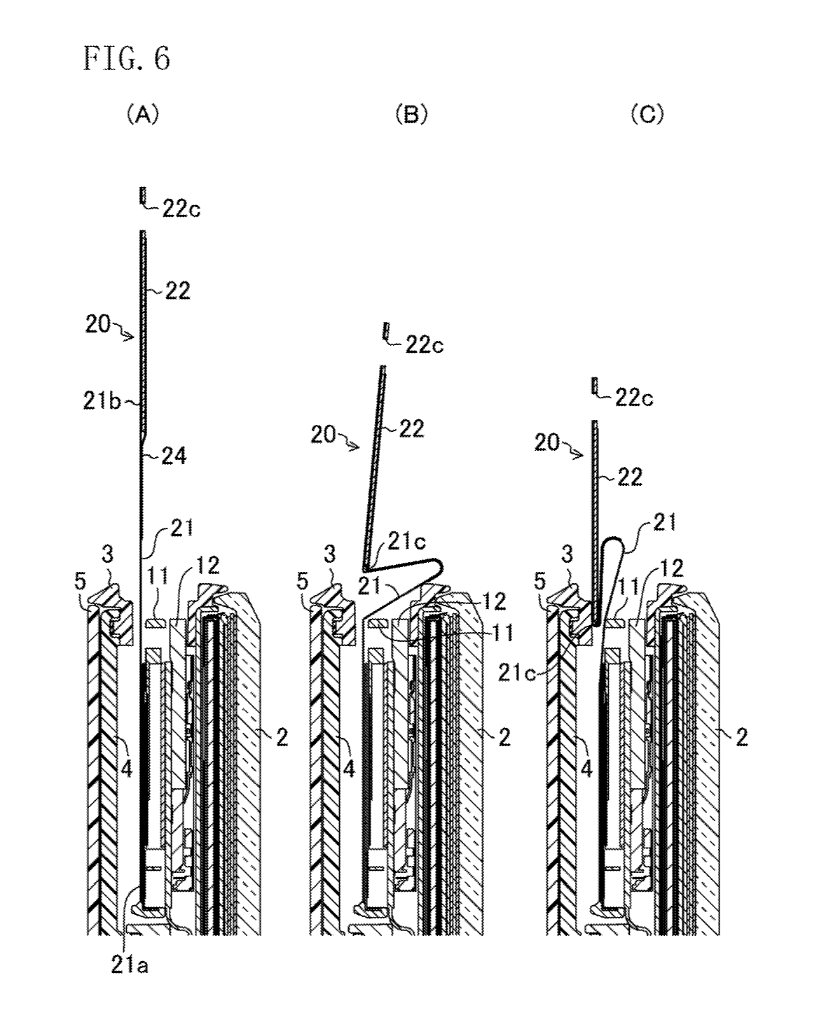

As shown in FIGS. 1 and 4, the main substrate 7 includes, for example, a sub-substrate 13 to which a SIM card tray 11 and an SD card 12 can be attached. An SD socket 12a is mounted on a front surface of the sub-substrate 13. The SD card 12 can be loaded in and unloaded from the SD socket 12a. The SIM card tray 11 can be loaded in and unloaded from a SIM socket 11a provided on a surface, of the sub-substrate 13, opposite to the surface to which the SD socket 12a is mounted. Note that the SIM socket 11a, the SD socket 12a, and other components may be provided on the main substrate 7, instead of the sub-substrate 13.

As shown in FIG. 4, a sub-substrate holder 14 is provided which is made of, for example, a resin and which covers the SIM socket 11a. An indication member configured as an indication sheet 20 is slidably housed near a backside of the sub-substrate holder 14.

FIG. 2 shows, on an enlarged scale, a state where a connector cover 10 which is, for example, long in a lateral direction is detached. As shown in FIG. 2, an indication sheet opening 3a which has, for example, an elliptic shape opens at an upper end of the front side cabinet 3, and each of the SIM card tray 11, the SD card 12, and the indication sheet 20 can be slid in and out through the indication sheet opening 3a. The indication sheet opening 3a is closed with the connector cover 10 which has, for example, a rectangular shape in a waterproof and dust-tight manner. Note that the indication sheet opening 3a may be provided on a lower end, a left side surface, or a right side surface of the smartphone 1, instead of the upper end. As shown in FIG. 1, the indication sheet opening 3a is defined only by the front side cabinet 3. However, the indication sheet opening 3a may be formed in any of the front side cabinet 3, the backside cabinet 4, and the rear cover 5. Further, the indication sheet opening 3a may be defined by two of more of these components.

As shown in Portions (A) and (B) of FIG. 5 and Portions (A) to (C) of FIG. 6, the indication sheet 20 includes a base sheet 21 which has one end portion 21a (a lower end portion) coupled to a portion located inward from the indication sheet opening 3a (an inner portion of the front side cabinet 3). The base sheet 21 is configured to be housed through the indication sheet opening 3a, while being at a folded position. The base sheet 21 is made of a sheet of, for example, PET resin, polycarbonate, or polyimide. As shown in Portions (A) to (C) of FIG. 6, the base sheet 21 suitably has an appropriate length such that the base sheet 21 fits inside the indication sheet opening 3a by being folded in two.

The base sheet 21 has the other end portion 21b continuing to a drawable part 22 which can be pulled out through the indication sheet opening 3a. In this embodiment, the other end portion 21b of the base sheet 21, which continues to the drawable part 22, has a greater stiffness than the rest of the base sheet 21. The drawable part 22 is made of, for example, a polycarbonate-based resin, a styrene-based resin, or a polyester-based resin. The drawable part 22 may be made using a metal material such as a stainless steel. The base sheet 21 and the drawable part 22 may be configured as an integral molding, or bonded to each other. The base sheet 21 and the drawable part 22 may be an integral molding of a UV curable resin. If the base sheet 21 is configured as a resin molding, the drawable part 22 may be formed as a portion of the base sheet 21 when the base sheet 21 is molded. In such a case the drawable part 22 is formed as a thick portion of the base sheet 21, thereby increasing the stiffness.

For example, the one end portion 21a of the base sheet 21 is bonded to the sub-substrate holder 14 with a double-faced tape 23.

The drawable part 22 has a projection 22a which has, for example, a rectangular shape. The projection 22a is formed to be positioned outside with respect to the indication sheet opening 3a and prevents the entire drawable part 22 from being deeply inserted inside the indication sheet opening 3a. The projection 22a is not limited to any particular shape.

The drawable part 22 further has a pair of anti-removal protrusions 22b which are located inward from the projection 22a and configured to engage with engagement recesses 14a formed on the sub-substrate holder 14 disposed inward with respect to the indication sheet opening 3a. The anti-removal protrusions 22b each protrude in an are shape and are integral with the drawable part 22. One anti-removal protrusion 22b may be provided only on the left or right side. When the indication sheet 20 is pulled out, the arc-shaped anti-removal protrusions 22b are caused to go over, and disengage from, the engagement recesses 14a. On the other hand, the anti-removal protrusions 22b prevent the drawable part 22 from being brought out unintentionally as long as a user does not pull the drawable part 22 relatively strongly. Since the anti-removal protrusions 22b have a round shape, the user can easily disengage the anti-removal protrusions 22b from the engagement recesses 14a by pulling the drawable part 22 relatively strongly.

The indication sheet 20 further includes a fingernail hold 22c having an elliptic shape and formed in an end portion in the direction in which the indication sheet 20 is pulled out (i.e., an upper portion of the indication sheet 20). The fingernail hold 22c is designed such that the user can pull the indication sheet 20 with his/her fingernail hooked into the fingernail hold 22c, for example.

As shown, for example, in Portion (B) of FIG. 6, the base sheet 21 can be folded at a coupling portion (a folding point 21c) where the other end portion 21b of the base sheet 21 is coupled to an innermost portion of the drawable part 22. Therefore, the base sheet 21 is always folded at the same folding point 21c, which makes it easy to handle the base sheet 21.

As shown in Portion (B) of FIG. 5, a label 24 is attached which extends from a portion of the drawable part 22 to a portion of the base sheet 21. The label 24 is a seal-like member on which important information, such as an IMEI and a serial number, is described. The label 24 itself has a length greater than the drawable part 22. Note that the label 24 may be attached to the opposite surface of the base sheet 21. In stead of the label 24 attached, the important information may be described directly on a surface of at least one of the drawable part 22 or the base sheet 21 by printing or inscribing, for example.

As shown in Portion (A) of FIG. 6, when the indication sheet 20 is at a pulled-out position, the entire label 24 is exposed outside the indication sheet opening 3a, and consequently, the user is allowed to visually confirm the information.

In this embodiment, since the indication sheet 20 is housed in the front side cabinet 3 with the base sheet 21 folded up, the front side cabinet 3 requires a small space for housing the indication sheet 20.

As shown in Portion (A) of FIG. 6, when the base sheet 21 is at the pulled-out position, the label 24 that is longer than the drawable part 22 having a relatively high stiffness (and not being foldable) is exposed outside the indication sheet opening 3a, and the label 24 bears the necessary information described thereon. Thus, this embodiment enables a larger amount of information to be described than in the configuration of the known art that does not include the base sheet 21.

Further, the projection 22a functions as a stopper and prevents the drawable part 22 from being inserted so deeply inside the indication sheet opening 3a that the user cannot pull out the drawable part 22.

According to this embodiment, when the indication sheet 20 is slid in and out, the base sheet 21 is always folded at the same folding point 21c. This makes it easy to house the base sheet 21, and reduces damage to the base sheet 21.

Configuring the base sheet 21 to be foldable and attaching the label 24 not only to the drawable part 22, but also to the base sheet 21 increase an indication area of the base sheet 21 and enables an increased amount of information to be described, without having to increase the space for housing the indication sheet 20.

As can be seen, the smartphone 1 according to this embodiment includes the base sheet 21 on which information can be described and of which the one end portion 21a is coupled to an inner portion of the front side cabinet 3 and the other end portion 21b continues to the drawable part 22. The base sheet 21 is folded up to be housed through the indication sheet opening 3a. Thus, as large an amount of information as possible may be described even if a limited space is available within the smartphone 1.

### —Variation of First Embodiment—

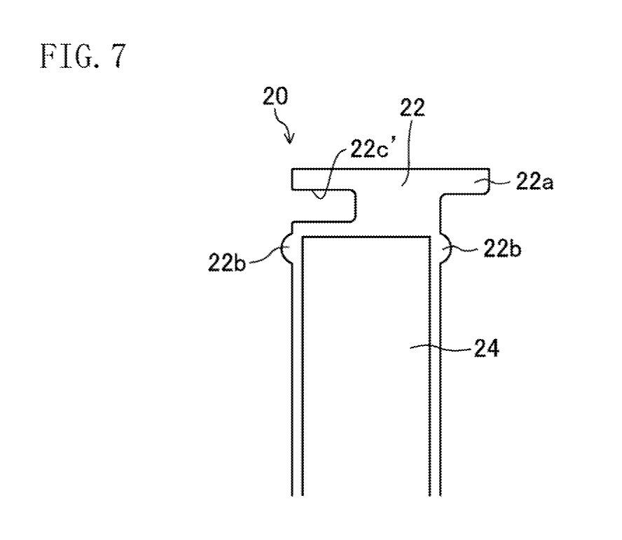

FIG. 7 shows a variation of the first embodiment of the present invention. This variation includes a fingernail hold 22c′ which has a different shape from the fingernail hold of the first embodiment. Note that in the following variations and embodiments, the same components as those shown in FIGS. 1 to 6 are denoted by the same reference characters, and the detailed explanation thereof will be omitted herein.

Specifically, the fingernail hold 22c′ of this variation is configured not as a through hole, but as a notch. While having a lower stiffness than the first embodiment described above, this configuration allows a user to hook his/her fingernail more easily.

### Second Embodiment

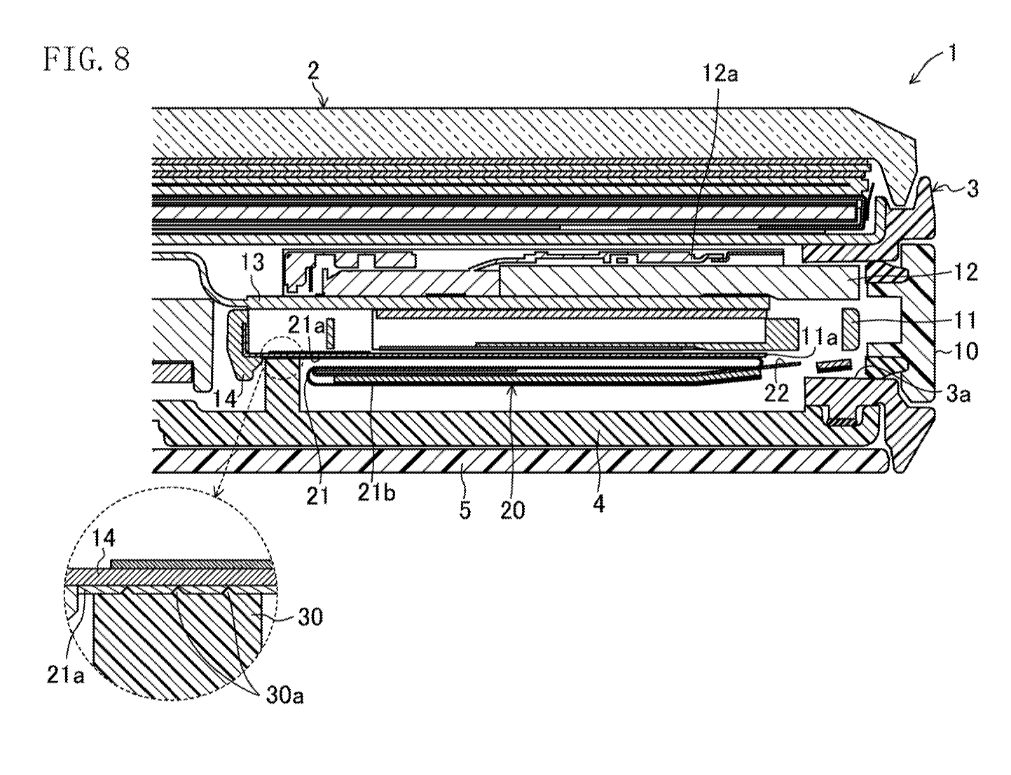

FIG. 8 shows a second embodiment of the present invention. In the second embodiment, the one end portion 21a of the base sheet 21 is fixed in a different manner from the first embodiment described above.

Specifically, in this embodiment, the one end portion 21a of the base sheet 21 is fixed to the front side cabinet 3, not with adhesion such as of the double-faced tape 23 of the first embodiment, but by being interposed. As shown on an enlarged scale in FIG. 8, a pressing portion 30 extends from the backside cabinet 4. The pressing portion 30 has, on its tip end, knurled protrusions 30a. Note that these protrusions 30a are not limited to this shape.

These protrusions 30a are capable of reliably pressing the one end portion 21a of the base sheet 21, which makes it difficult for the base sheet 21 to be removed even when the drawable part 22 is pulled. This configuration may eliminate need for attaching the double-faced tape 23 or applying an adhesive.

### —Variation of Second Embodiment—

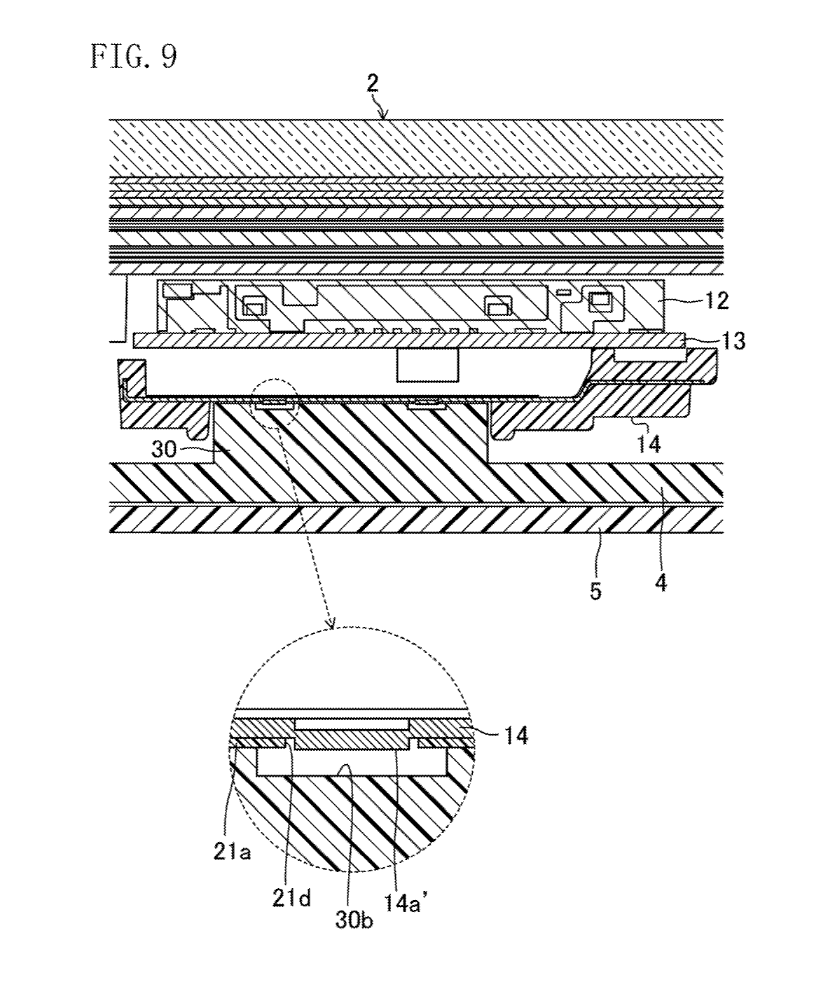

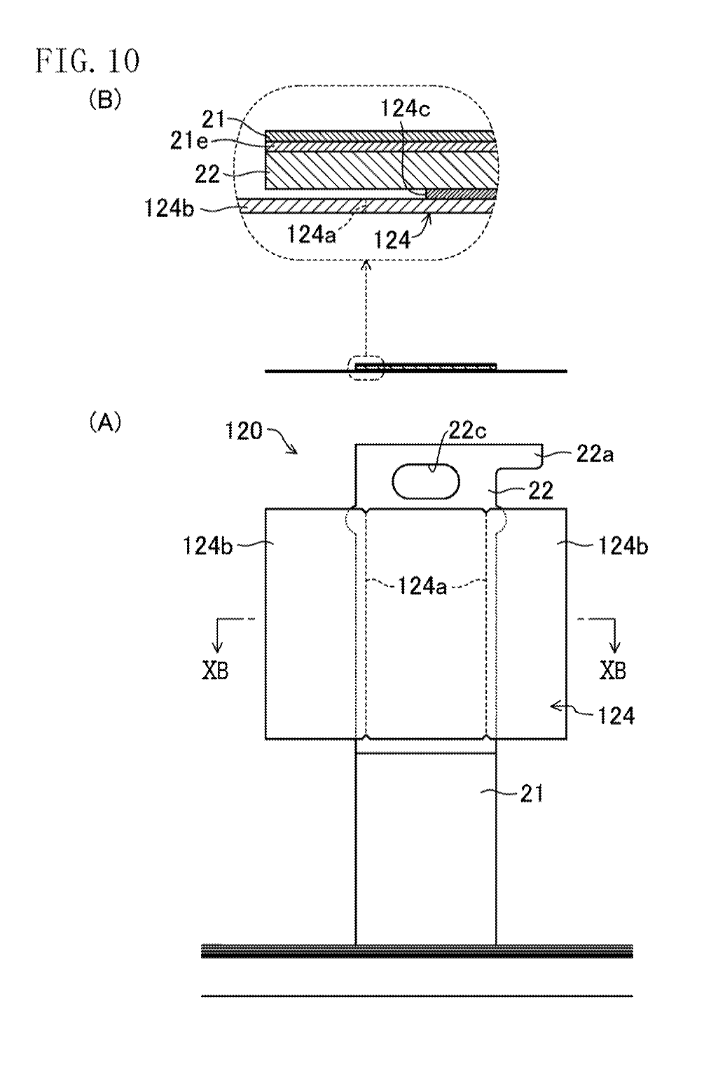

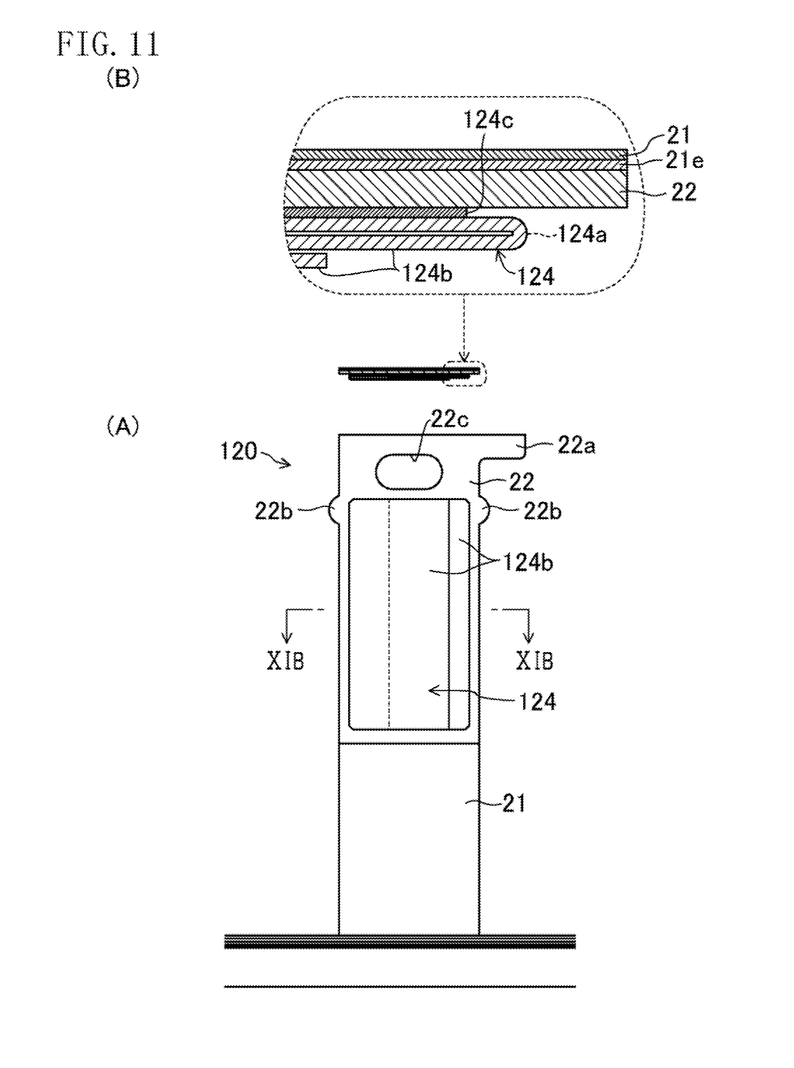

FIG. 9 shows a variation of the second embodiment of the present invention. This variation includes an interposing and fastening structure which differs from that of the second embodiment described above. Note that FIG. 9 shows a cross section orthogonal to FIG. 1 and other drawings.

As shown in FIG. 9, anti-removal projections 14a′ project from the sub-substrate holder 14. The base sheet 21 has, in the one end portion 21a, through holes 21d corresponding to the anti-removal projections 14a′. Forming a recess 30b on the tip end of the pressing portion 30 prevents the pressing portion 30 from interfering with the anti-removal projections 14a′ even though the anti-removal projections 14a′ project toward the pressing portion 30. This configuration also makes it difficult for the base sheet 21 to be removed.

### Third Embodiment

Portions (A) and (B) of FIG. 10 and Portions (A) and (B) of FIG. 11 show an indication sheet 120 according to a third embodiment of the present invention. The indication sheet 120 is provided with a label 124 having a different shape from those of the embodiments described above.

Specifically, when the indication sheet 120 is at a pulled-out position, the label 124 having unfoldable portions 124b can be further opened in a direction orthogonal to the direction in which the indication sheet 120 is pulled out. Thus, the indication sheet 120 has an increased indication area where an increased amount of information may be described.

Specifically, the label 124 itself, which is attached to the drawable part 22, is foldable and unfoldable in the width direction of the drawable part 22. As shown on an enlarged scale in Portion (B) of FIG. 10, the base sheet 21 is attached to the drawable part 22 with a double-faced tape 21e.

The label 124 of this embodiment is attached to the drawable part 22 with a double-faced tape 124c. The label 124 itself has a certain thickness and a certain strength.

As shown in Portions (A) and (B) of FIG. 10, the label 124 includes, on its left and right portions, creases 124a extending in the direction in which the indication sheet 120 is pulled out, and the unfoldable portions 124b extend outwardly respectively from the left and right creases 124a. The label 124 has an area where information is described not only on its portion attached to the drawable part 22, but also on the pair of unfoldable portions 124b. Thus, an increased amount of information may be described on the label 124. Note that one unfoldable portion 124b may be provided only on the left or right side.

As shown in Portions (A) and (B) of FIG. 11, the label 124 may be housed with the unfoldable portions 124b folded along the creases 124a. While being in such a state, the indication sheet 120 is housed according to the process shown in Portions (A) to (C) of FIG. 6 of the first embodiment described above.

As can be seen, configuring the label 124 to be foldable and unfoldable may leads a further increase in the amount of information describable on the label 124, without having to increase the space for housing the indication sheet 120.

### —Variation of Third Embodiment—

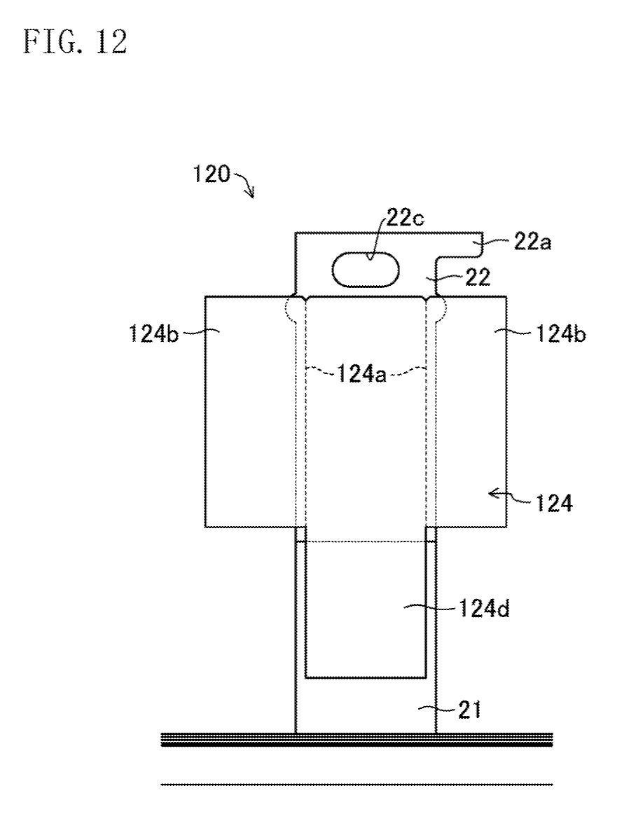

FIG. 12 shows a variation of the third embodiment of the present invention. This variation includes a label 124 having a different shape from that of the third embodiment described above.

Specifically, likewise the first embodiment described above, the label 124 of this variation has an extension portion 124d which extends also on the base sheet 21 which is folded. Thus, this variation may lead an increase in the amount of describable information, without having to increase the space for housing the indication sheet 120.

### OTHER EMBODIMENTS

The above embodiments of the present invention may be configured as follows.

Specifically, in the embodiments described above, the indication sheets 20 and 120 are each capable of being slidably housed in the sub-substrate holder 14. However, the indication sheets 20 and 120 may be configured to be slidably housed in a portion of the casing, such as the front side cabinet 3 and the backside cabinet 4, instead of the sub-substrate holder 14.

In the embodiments described above, the important information including an IMEI and a serial number is described on the indication sheets 20 and 120. However, the present invention is not limited to this, and other matters such as handling precautions of the product may be described on the indication sheets 20 and 120.

In the embodiments described above, the electronic device is configured as the smartphone 1. However, the electronic device may be configured as a tablet terminal, a personal handy-phone system (PHS), a personal digital assistant (PDA), a PC, a mobile tool, a wearable terminal, an electronic dictionary, a calculator, a game console, a small liquid crystal display, a liquid crystal television, a Blu-ray disc reorder, a DVD recorder, or any other electronic device. That is to say, the present invention is widely applicable to devices which have a structure in which an indication member for indicating information can be pulled out.

The foregoing embodiments are merely beneficial examples in nature, and are not intended to limit the scope, application, or uses of the present invention. The technical features specified in the foregoing description of the embodiments may be combined with each other, and such a combination may create a new technical feature.

### DESCRIPTION OF REFERENCE CHARACTERS

1 Smartphone (Electronic Device)
2. Liquid Crystal Display Unit
3 Front Side Cabinet (Casing)
3a Indication Sheet Opening (Indication Member Opening)
4 Backside Cabinet
5 Rear Cover
6 Rechargeable Battery
7 Main Substrate
10 Connector Cover
11 SIM Card Tray
11a SIM Socket
12 SD Card
12a SD Socket
13 Sub-Substrate
14 Sub-Substrate Holder
14a Engagement Recess
14a′ Anti-Removal Projection
20 Indication Sheet (Indication Member)
21 Base Sheet
21a One End Portion
21b The Other End Portion
21c Folding Point
21d Through Hole
21e Double-Faced Tape
22 Drawable Part
22a Projection
22b Anti-Removal Protrusion
22c Fingernail Hold
22c′ Fingernail Hold
23 Double-Faced Tape
24 Label
30 Pressing Portion
30a Protrusion
30b Recess
120 Indication Sheet (Indication Member)
124 Label
124a Crease
124b Unfoldable Portion
124c Double-Faced Tape
124d Extension Portion

1. An electronic device comprising: an indication member which can be slid in and out; and a casing having an indication member opening through which the indication member is slid in and out of the casing, wherein
the indication member includes
a base sheet which has one end portion coupled to a portion located inward from the indication member opening, and which is configured to be housed while being at a folded position, and
a drawable part which continues to the other end portion of the base sheet and which is able to be pulled out through the indication member opening, and
the electronic device is configured such that when the base sheet is at a pulled-out position, information described on the indication member is exposed outside the indication member opening.

2. The electronic device of claim 1, wherein
the drawable part has a projection which is positioned outside with respect to the indication member opening and configured to prevent the entire drawable part from being inserted deeply inside the indication member opening.

3. The electronic device of claim 2, wherein
the drawable part further includes an anti-removal protrusion which is located inward from the projection, and which is configured to engage with an engagement recess formed inward with respect to the indication member opening and to disengage from the engagement recess when the indication member is pulled out.

4. The electronic device of claim 1, wherein
the base sheet is foldable at a coupling portion at which the other end portion of the base sheet is coupled to an innermost portion of the drawable part.

5. The electronic device of claim 1, wherein
the indication member includes an unfoldable portion which is openable in a direction orthogonal to a direction in which the indication member is pulled out when the indication member is at the pulled-out position.
